(19) United States
(12) Patent Application Publication
(10) Pub. No.: US 2026/0223153 A1
(43) Pub. Date: Jul. 30, 2026

(54) TRANSMITTER-ASSISTED HARMONIC AVOIDANCE AT WIRELESS NODES

(71) Applicant: QUALCOMM Incorporated, San Diego, CA (US)

(72) Inventors: Yavuz YAPICI, Florham Park, NJ (US); Juergen CEZANNE, Ocean Township, NJ (US); Junyi LI, Greentown, PA (US)

(21) Appl. No.: 19/036,878

(22) Filed: Jan. 24, 2025

(51) Int. Cl. H04W 72/541; H04B 17/318; H04W 72/0453

(52) U.S. Cl. CPC H04W 72/541; H04B 17/318; H04W 72/0453

(57) ABSTRACT

Methods, systems, and devices for wireless communications are described. Generally, the described techniques enable a first wireless device to suppress higher-order harmonic frequencies in a reflected signal using subcarrier allocation and one or more harmonic suppression windows in an incident signal. For example, the first wireless device may determine a resource allocation across multiple resource elements (REs) of the incident signal. Within the resource allocation, a respective harmonic suppression window may include a first symbol mapped to a first RE to be reflected to the first-order harmonic frequency of the reflected signal and multiple null symbols mapped to REs that correspond to higher-order harmonic frequencies of the reflected signal. The null symbols in the harmonic suppression window may suppress interference from the higher-order harmonic frequencies, which may enable the second wireless device to more-accurately detect the first symbol.

### FIELD OF TECHNOLOGY

The following relates to wireless communications, including transmitter-assisted harmonic avoidance at wireless nodes.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a first wireless device may communicate with a second wireless device via a wireless node (e.g., an ambient Internet-of-Things device or reconfigurable intelligent surface device) using reflection modulation techniques.

### SUMMARY

The systems, methods, and devices of this disclosure each have several innovative aspects, no single one of which is solely responsible for the desirable attributes disclosed herein.

A method for wireless communications by a first wireless device is described. The method may include determining a resource allocation across a set of multiple resource elements (REs), where the resource allocation includes a first symbol mapped to a first RE and one or more harmonic suppression windows, where the first RE is associated with an incident signal to a second wireless device and each of the one or more harmonic suppression windows include a set of multiple null symbols mapped to REs corresponding to harmonics of the incident signal within a harmonic order of the first RE and transmitting a first signal based on performing an inverse Fourier transform operation on the set of multiple REs.

A first wireless device for wireless communications is described. The first wireless device may include one or more memories storing processor executable code, and one or more processors coupled with the one or more memories. The one or more processors may individually or collectively be operable to execute the code to cause the first wireless device to determine a resource allocation across a set of multiple REs, where the resource allocation includes a first symbol mapped to a first RE and one or more harmonic suppression windows, where the first RE is associated with an incident signal to a second wireless device and each of the one or more harmonic suppression windows include a set of multiple null symbols mapped to REs corresponding to harmonics of the incident signal within a harmonic order of the first RE and transmit a first signal based on performing an inverse Fourier transform operation on the set of multiple REs.

Another first wireless device for wireless communications is described. The first wireless device may include means for determining a resource allocation across a set of multiple REs, where the resource allocation includes a first symbol mapped to a first RE and one or more harmonic suppression windows, where the first RE is associated with an incident signal to a second wireless device and each of the one or more harmonic suppression windows include a set of multiple null symbols mapped to REs corresponding to harmonics of the incident signal within a harmonic order of the first RE and means for transmitting a first signal based on performing an inverse Fourier transform operation on the set of multiple REs.

A non-transitory computer-readable medium storing code for wireless communications is described. The code may include instructions executable by one or more processors to determine a resource allocation across a set of multiple REs, where the resource allocation includes a first symbol mapped to a first RE and one or more harmonic suppression windows, where the first RE is associated with an incident signal to a second wireless device and each of the one or more harmonic suppression windows include a set of multiple null symbols mapped to REs corresponding to harmonics of the incident signal within a harmonic order of the first RE and transmit a first signal based on performing an inverse Fourier transform operation on the set of multiple REs.

Some examples of the method, first wireless devices, and non-transitory computer-readable medium described herein may further include operations, features, means, or instructions for transmitting a first indication of the resource allocation and receiving a second indication of a signal-to-interference plus noise ratio (SINR) of the first signal, a received signal strength indicator (RSSI) of the first signal, or any combination thereof, based on the first indication. Some examples of the method, first wireless devices, and non-transitory computer-readable medium described herein may further include operations, features, means, or instructions for transmitting a second signal associated with one or more second harmonic suppression windows, where a quantity of the one or more second harmonic suppression windows may be different from a quantity of the one or more harmonic suppression windows based on the second indication.

Some examples of the method, first wireless devices, and non-transitory computer-readable medium described herein may further include operations, features, means, or instructions for transmitting a second signal associated with one or more second harmonic suppression windows, where a second set of multiple null symbols in the one or more second harmonic suppression windows may be different from a quantity of the set of multiple null symbols in the one or more harmonic suppression windows based on the second indication.

Some examples of the method, first wireless devices, and non-transitory computer-readable medium described herein may further include operations, features, means, or instructions for transmitting a first indication of a chip rate for use by the second wireless device, where the set of multiple null symbols in the one or more harmonic suppression windows may be based on the chip rate.

In some examples of the method, first wireless devices, and non-transitory computer-readable medium described herein, the resource allocation further includes a set of multiple second symbols and each symbol of the set of multiple second symbols may be mapped to a respective RE outside of the one or more harmonic suppression windows. In some examples of the method, first wireless devices, and non-transitory computer-readable medium described herein, the set of multiple second symbols may be mapped across all REs of the set of multiple REs outside of the one or more harmonic suppression windows. In some examples of the method, first wireless devices, and non-transitory computer-readable medium described herein, the resource allocation further includes a second set of multiple null symbols, one or more null symbols of the second set of multiple null symbols may be between one or more symbols of the set of multiple second symbols, and placement of the one or more null symbols may be associated with the harmonic order of the first RE.

Some examples of the method, first wireless devices, and non-transitory computer-readable medium described herein may further include operations, features, means, or instructions for determining a guard band between a respective harmonic suppression window of the one or more harmonic suppression windows and a next symbol mapped to a next RE outside of the respective harmonic suppression window, the guard band including a second set of multiple null symbols. In some examples of the method, first wireless devices, and non-transitory computer-readable medium described herein, a width of the guard band may be based on the harmonics of the incident signal and a chip rate of the second wireless device.

Some examples of the method, first wireless devices, and non-transitory computer-readable medium described herein may further include operations, features, means, or instructions for determining one or more even-order harmonics of the harmonics of the incident signal, where the resource allocation further includes one or more second symbols mapped to one or more second REs within the one or more harmonic suppression windows that correspond to the one or more even-order harmonics.

A method for wireless communications by a second wireless device is described. The method may include receiving an indication of a resource allocation across a set of multiple REs, where the resource allocation includes a first symbol mapped to a first RE and one or more harmonic suppression windows, where the first RE is associated with an incident signal to a first wireless device and the one or more harmonic suppression windows include a set of multiple null symbols mapped to REs corresponding to harmonics of the incident signal within a harmonic order of the first RE and receiving, based on the indication, a first signal associated with the incident signal.

A second wireless device for wireless communications is described. The second wireless device may include one or more memories storing processor executable code, and one or more processors coupled with the one or more memories. The one or more processors may individually or collectively be operable to execute the code to cause the second wireless device to receive an indication of a resource allocation across a set of multiple REs, where the resource allocation includes a first symbol mapped to a first RE and one or more harmonic suppression windows, where the first RE is associated with an incident signal to a first wireless device and the one or more harmonic suppression windows include a set of multiple null symbols mapped to REs corresponding to harmonics of the incident signal within a harmonic order of the first RE and receive, based on the indication, a first signal associated with the incident signal.

Another second wireless device for wireless communications is described. The second wireless device may include means for receiving an indication of a resource allocation across a set of multiple REs, where the resource allocation includes a first symbol mapped to a first RE and one or more harmonic suppression windows, where the first RE is associated with an incident signal to a first wireless device and the one or more harmonic suppression windows include a set of multiple null symbols mapped to REs corresponding to harmonics of the incident signal within a harmonic order of the first RE and means for receiving, based on the indication, a first signal associated with the incident signal.

A non-transitory computer-readable medium storing code for wireless communications is described. The code may include instructions executable by one or more processors to receive an indication of a resource allocation across a set of multiple REs, where the resource allocation includes a first symbol mapped to a first RE and one or more harmonic suppression windows, where the first RE is associated with an incident signal to a first wireless device and the one or more harmonic suppression windows include a set of multiple null symbols mapped to REs corresponding to harmonics of the incident signal within a harmonic order of the first RE and receive, based on the indication, a first signal associated with the incident signal.

Some examples of the method, second wireless devices, and non-transitory computer-readable medium described herein may further include operations, features, means, or instructions for determining an SINR of the first signal, an RSSI of the first signal, or any combination thereof based on receipt of the first signal and transmitting a second indication of the SINR, the RSSI, or any combination thereof. Some examples of the method, second wireless devices, and non-transitory computer-readable medium described herein may further include operations, features, means, or instructions for receiving a second signal associated with one or more second harmonic suppression windows, where a quantity of the one or more second harmonic suppression windows may be different from a quantity of the one or more harmonic suppression windows based on the second indication.

Some examples of the method, second wireless devices, and non-transitory computer-readable medium described herein may further include operations, features, means, or instructions for receiving a second signal associated with one or more second harmonic suppression windows, where a second set of multiple null symbols in the one or more second harmonic suppression windows may be different from a quantity of the set of multiple null symbols in the one or more harmonic suppression windows based on the second indication.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support transmitter-assisted harmonic avoidance at wireless nodes in accordance with one or more aspects of the present disclosure.

FIG. 3 shows an example of a resource allocation scheme that supports transmitter-assisted harmonic avoidance at wireless nodes in accordance with one or more aspects of the present disclosure.

FIGS. 4A through 4C show examples of harmonic suppression window schemes that support transmitter-assisted harmonic avoidance at wireless nodes in accordance with one or more aspects of the present disclosure.

FIG. 5 shows an example of a process flow that supports transmitter-assisted harmonic avoidance at wireless nodes in accordance with one or more aspects of the present disclosure.

FIGS. 6 and 7 show block diagrams of devices that support transmitter-assisted harmonic avoidance at wireless nodes in accordance with one or more aspects of the present disclosure.

FIG. 8 shows a block diagram of a communications manager that supports transmitter-assisted harmonic avoidance at wireless nodes in accordance with one or more aspects of the present disclosure.

FIG. 10 shows a diagram of a system including a UE that supports transmitter-assisted harmonic avoidance at wireless nodes in accordance with one or more aspects of the present disclosure.

FIG. 9 shows a diagram of a system including a network entity that supports transmitter-assisted harmonic avoidance at wireless nodes in accordance with one or more aspects of the present disclosure.

FIGS. 11 and 12 show flowcharts illustrating methods that support transmitter-assisted harmonic avoidance at wireless nodes in accordance with one or more aspects of the present disclosure.

### DETAILED DESCRIPTION

In some wireless communications systems, backscatter communications may be used in various low-power or battery-less wireless nodes, such as ambient Internet of Things (A-IoT) devices or devices that include reconfigurable intelligent surfaces (RISs). For example, a wireless node may receive an incident signal from a first wireless device (e.g., a transmitter device) and reflect the signal with a type of modulation (e.g., a frequency shift, a phase shift, an amplitude shift, or any combination thereof), which may be called reflection modulation, to a second wireless device (e.g., a reader device). In some examples, an incident signal may refer to a signal that is transmitted by the first wireless device for the purpose of reflection modulation being applied by the second wireless device (e.g., the signal prior to reflection modulation at the second wireless device or other wireless node that may create additional signal components including harmonics). Some wireless communications systems may perform reflection modulation using periodic waveforms that may switch patterns of antenna loads of a respective wireless node, thereby inducing a desired phase shift on the reflected signal. In some examples, the second wireless device may detect the phase shift in a first-order harmonic frequency of the reflected signal to obtain information from the first wireless device, the wireless node, or both. However, the reflected signal may also include higher-order harmonic frequencies (as a result of using periodic modulating waveforms) that may introduce interference and degrade a capability of the second wireless device to detect the phase shift in the first-order harmonic frequency. In some examples, various techniques to suppress the higher-order harmonic frequencies may be implemented at the wireless node, but these techniques may introduce undesirable complexity and increased costs at the wireless node.

In accordance with the techniques described herein, the first wireless device may suppress higher-order harmonic frequencies in the reflected signal using subcarrier allocation and one or more harmonic suppression windows in the incident signal. For example, the first wireless device may determine a resource allocation across multiple resource elements (REs) of the incident signal. Within the resource allocation, a respective harmonic suppression window may include a first symbol mapped to a first RE to be reflected to the first-order harmonic frequency of the reflected signal as well as multiple null symbols mapped to REs that correspond to higher-order harmonic frequencies of the reflected signal. The null symbols in the harmonic suppression window may suppress (e.g., eliminate, or substantially eliminate) interference from the higher-order harmonic frequencies (e.g., energy that would be reflected to the first-order harmonic frequency by higher order harmonics if non-zero symbols were present), which may enable the second wireless device to more-accurately detect a frequency or phase shift of the first symbol.

In some examples, the first wireless device may determine the resource allocation in accordance with one or more harmonic window suppression schemes. For example, the first wireless device may adjust a quantity of harmonic suppression windows in the incident signal waveform (e.g., in the transmission prior to reflection), a quantity of occupied REs outside of the harmonic suppression windows in the incident signal waveform, a width of a guard band between occupied REs outside of the harmonic suppression windows and the harmonic suppression windows, or any combination thereof, in accordance with a harmonic suppression window scheme. In some examples, the first wireless device may select a harmonic suppression window scheme based on a quantity of user equipments (UEs) served by the first wireless device (e.g., the first wireless device may select a scheme that supports transmitting more data to the UEs). Additionally, or alternatively, the first wireless device may select a harmonic suppression window scheme based on communicating with the second wireless device. For example, the second wireless device may transmit an indication of a success quality for detection and the first wireless device may select a scheme based on the indication (e.g., select a scheme with higher suppression based on a low detection success at the reader).

Aspects of the disclosure are initially described in the context of wireless communications systems. Aspects of the disclosure are then illustrated by and described with reference to a resource allocation scheme, harmonic suppression window schemes, and a process flow. Aspects of the disclosure are further illustrated by and described with reference to apparatus diagrams, system diagrams, and flowcharts that relate to transmitter-assisted harmonic avoidance at wireless nodes.

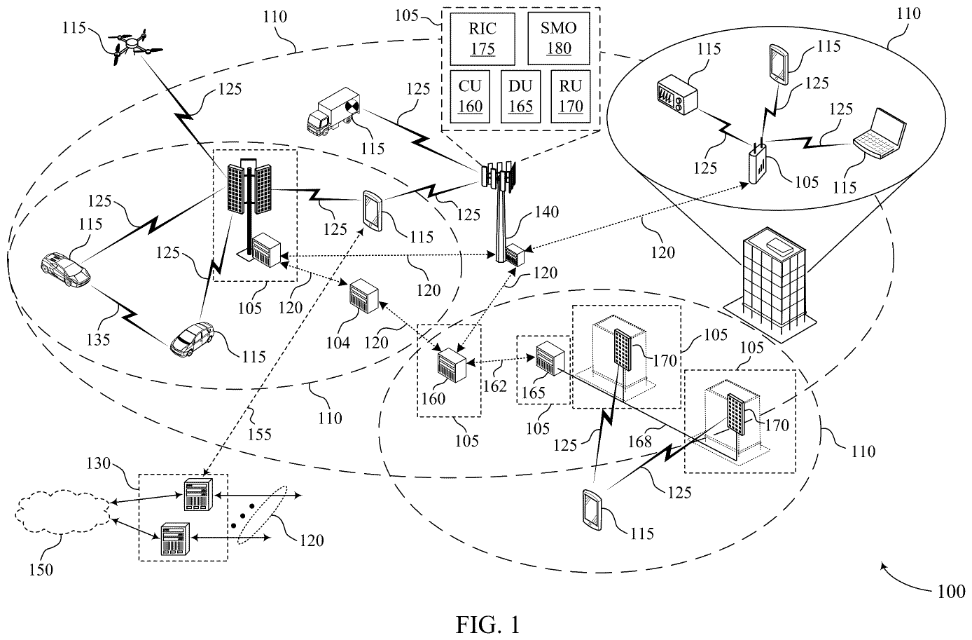

FIG. 1 shows an example of a wireless communications system 100 that supports transmitter-assisted harmonic avoidance at wireless nodes in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support transmitter-assisted harmonic avoidance at wireless nodes as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, reflection modulation may be used in various low-power or battery-less wireless nodes, such as A-IoT devices or devices that include RISs. For example, a wireless node may receive an incident signal from a first wireless device (e.g., a network entity 105 or a UE 115) and reflect the signal with a type of modulation (e.g., a frequency shift, a phase shift, an amplitude shift, or any combination thereof), which may be called reflection modulation, to a second wireless device (e.g., a network entity 105 or a UE 115). Some wireless communications systems may perform reflection modulation using periodic waveforms that may switch patterns of antenna loads of a respective wireless node, thereby inducing a desired phase shift on the reflected signal. In some examples, the second wireless device may detect the phase shift in a first-order harmonic frequency of the reflected signal to obtain information from the first wireless device, the wireless node, or both. However, the reflected signal may also include higher-order harmonic frequencies (as a result of using periodic modulating waveforms) that may introduce interference and degrade a capability of the second wireless device to detect the phase shift in the first-order harmonic frequency. In some examples, various techniques to suppress the higher-order harmonic frequencies may be implemented at the wireless node, but these techniques may introduce undesirable complexity and increased costs at the wireless node.

The wireless communications system 100 may enable the first wireless device to suppress higher-order harmonic frequencies in the reflected signal using subcarrier allocation and one or more harmonic suppression windows in the incident signal. For example, the first wireless device may determine a resource allocation across multiple REs of the incident signal. Within the resource allocation, a respective harmonic suppression window may include a first symbol mapped to a first RE for reflection to the first-order harmonic frequency of the reflected signal as well as multiple null symbols mapped to REs that correspond to higher-order harmonic frequencies of the reflected signal. The null symbols in the harmonic suppression window may suppress (e.g., eliminate, or substantially eliminate) interference from the higher-order harmonic frequencies, which may enable the second wireless device to more-accurately detect a frequency or phase shift of the first symbol.

In some examples, the first wireless device may determine the resource allocation in accordance with one or more harmonic window suppression schemes. For example, the first wireless device may adjust a quantity of harmonic suppression windows in the incident signal waveform, a quantity of occupied REs outside of the harmonic suppression windows in the incident signal waveform, a width of a guard band between occupied REs outside of the harmonic suppression windows and the harmonic suppression windows, or any combination thereof, in accordance with a harmonic suppression window scheme. In some examples, the first wireless device may select a harmonic suppression window scheme based on a quantity of UEs 115 served by the first wireless device (e.g., the first wireless device may select a scheme that supports transmitting more data to the UEs 115 where more UEs are served or more data is present for communication to UEs served by the first wireless device). Additionally, or alternatively, the first wireless device may select a harmonic suppression window scheme based on communicating with the second wireless device. For example, the second wireless device may transmit an indication of a success quality for detection and the first wireless device may select a scheme based on the indication (e.g., select a scheme with higher suppression based on a low detection success at the reader).

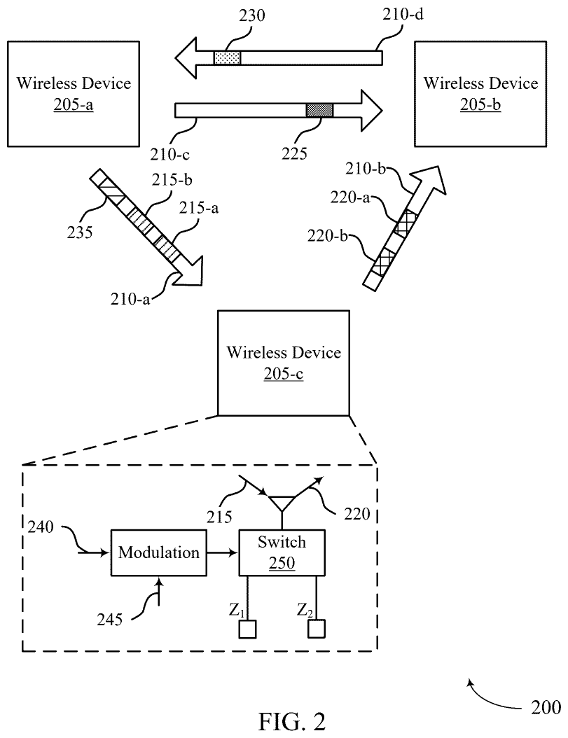

FIG. 2 shows an example of a wireless communications system 200 that supports transmitter-assisted harmonic avoidance at wireless nodes in accordance with one or more aspects of the present disclosure. The wireless communications system 200 may implement or be implemented by aspects of the wireless communications system 100. For example, the wireless communications system 200 may include wireless devices 205, which may be examples of one or more UEs 115, one or more network entities 105, or any combination thereof, as described with reference to FIG. 1. The wireless devices 205 may communicate signaling via one or more communication links 210 (e.g., a communication link 125 as described with reference to FIG. 1).

In some examples, a wireless device 205-a may communicate with a wireless device 205-c via a communication link 210-a, and the wireless device 205-c may communicate with a wireless device 205-b via a communication link 210-b. Additionally, or alternatively, the wireless device 205-a may communicate with the wireless device 205-b via communication links 210-c and 210-d (e.g., wireless communication links, backhaul communication links, midhaul communication links, or fronthaul communication links). In some cases, the wireless device 205-a and the wireless device 205-b may be the same wireless device 205 (e.g., the wireless device 205-a may be an emitter and the wireless device 205-b may be a reader in the same device). In some examples, the wireless device 205-c may be a wireless node, such as an ambient IoT device. Additionally, or alternatively, the wireless device 205-c may include one or more RISs.

In some examples, the wireless device 205-c may receive signaling (e.g., a an incident signal such as signal 215) from the wireless device 205-a via the communication link 210-a, perform reflection modulation on the signaling, and transmit (e.g., reflect) the modulated signaling (e.g., a reflected signal such as signal 220) to the wireless device 205-b via the communication link 210-b. The wireless device 205-c may transmit information to the wireless device 205-b based on performing the reflection modulation (e.g., information may be encoded in a phase shift, amplitude shift, or a combination thereof of the reflected signaling relative to the received signaling).

In some examples, the wireless device 205-c may perform the reflection modulation using one or more periodic waveforms that may determine (e.g., govern) one or more switching patterns of one or more antenna loads of the wireless device 205-c, and the one or more periodic waveforms may induce a phase shift on the reflected signaling (e.g., to transmit the information). For example, a switch 250 (e.g., an RF switch) may switch between multiplexing a signal 215, x(t), with a first antenna load, Z₁, and multiplexing the signal 215 with a second antenna load, Z₂, in accordance with a periodic waveform. In some cases, the periodic waveform may be generated based on modulating a clock signal 240 of the wireless device 205-c with data 245 (e.g., the information to be transmitted) from the wireless device 205-c. The first and second antenna loads may reflect a signal 220, y(t), that includes a different phase value than the signal 215 based on the periodic waveform. The signal 220 may be represented as y(t)=s(t)x(t), where s(t) is a reflection coefficient of the periodic waveform at a time t.

In some examples, a periodic waveform may be represented as a weighted sum of harmonic frequencies and respective coefficients in the frequency domain (e.g., Fourier series coefficients). A harmonic frequency may be an integer multiple (e.g., an odd integer multiple, an even integer multiple) of a base frequency (e.g., a fundamental frequency) of the periodic waveform. Coefficients of the periodic waveform in the frequency domain may be inversely proportional to their harmonic order. For example, the periodic waveform may include higher power for lower order harmonics (e.g., the most power may be in the first-order harmonic). The signal 220 in the frequency domain may be given by:

$${Y}_{k} = \frac{2}{i π} {X}_{k - \frac{M}{2}} - \frac{2}{i π} {X}_{k + \frac{M}{2}} + {\sum }_{{l = 3}_{l : odd}}^{∞} \frac{2}{i π l} ( {X}_{k - \frac{l M}{2}} - {X}_{k + \frac{l M}{2}} ) \qquad ( 1 )$$

where l is the harmonic order and M is the chip rate of the periodic waveform divided by the base frequency of the periodic waveform (e.g., the rate of each pulse in the periodic waveform with respect to a subcarrier spacing of the periodic waveform). The first and second terms of equation 1,

$$\frac{2}{i π} {X}_{k - \frac{M}{2}} - \frac{2}{i π} {X}_{k + \frac{M}{2}} ,$$

may each include the first-harmonic frequency (e.g., because l=1), and the third term may include the higher-order harmonics. Each harmonic frequency may have a corresponding image tone (e.g.,

$${X}_{k + \frac{M}{2}}$$

may be the image tone of

$${X}_{k - \frac{M}{2}} ) .$$

Based on equation 1, the quantity of frequency shift or modulation of the signal 215 (e.g.,

$${X}_{k - \frac{lM}{2}} )$$

may be based on the first-order harmonic frequency.

The wireless device 205-b may receive the information from the wireless device 205-c based on determining the quantity of frequency shift in the signal 220. For example, the wireless device 205-b may obtain the information based on detecting a frequency shift in the signal 220 relative to the signal 215. However, higher-order harmonics in the signal 220 may introduce interference (e.g., inter-harmonic interference) that may reduce a capability of the wireless device 205-b to detect the quantity of frequency shift in the signal 220. Some other wireless communications systems may suppress the higher-order harmonics at the wireless device 205-c, but suppressing the higher-order harmonics may introduce undesirably more complex hardware designs, signal processing designs, or a combination thereof, at the wireless device 205-c. Accordingly, it may be beneficial to suppress higher-order harmonics without introducing undue complexity at the wireless device 205-c.

The techniques described herein enable the wireless device 205-a (e.g., an emitter device) to suppress the higher-order harmonic frequencies in the signal 220 (e.g., without change at the wireless device 205-c) using subcarrier allocation and one or more harmonic suppression windows. For example, the wireless device 205-a may determine a resource allocation across multiple REs of a signal 215-a (e.g., the incident signal), where the resource allocation may include a first symbol mapped to a first RE to be reflected to a first-order harmonic frequency of a reflected signal and one or more harmonic suppression windows. Each of the one or more harmonic suppression windows may include multiple null symbols (e.g., allocated no energy) mapped to REs for reflection to higher-order harmonic frequencies of a signal 220-a (e.g., the reflected signal of signal 215-a). The one or more harmonic suppression windows may reduce interference from higher-order harmonics, which may enable the wireless device 205-b to detect the first symbol (e.g., detect the frequency shift of the first symbol).

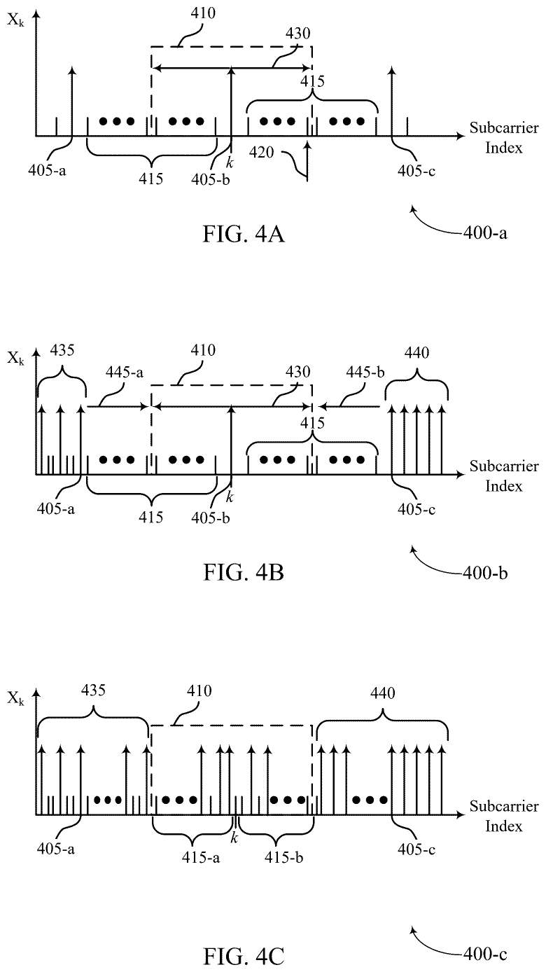

In some examples, the wireless device 205-a may determine the resource allocation based on one or more parameters. For example, the wireless device 205-a may determine a quantity of the one or more harmonic suppression windows based on whether the wireless device 205-a is in communication with (e.g., serves) one or more UEs 115 different than the wireless device 205-c. If the wireless device 205-a is not in communication with another UE 115, the wireless device 205-a may transmit the signal 215-a in accordance with a first harmonic window suppression scheme, as described further with reference to FIG. 4A. For example, the wireless device 205-a may allocate a bandwidth (e.g., the whole bandwidth) of the signal 215-a for the reflection operation (e.g., the wireless device 205-a may include multiple harmonic suppression windows within the signal 215-a). The wireless device 205-a may adjust a quantity of harmonics to suppress (e.g., a width of each of the harmonic suppression windows) based on a detection quality at the wireless device 205-b. For example, suppressing less harmonics may free-up bandwidth to increase a quantity of harmonic suppression windows, thereby improving detection success of the information in the signal 220-a at the wireless device 205-b.

In some other examples, if the wireless device 205-a is in communication with (e.g., serves) one or more UEs and one or more wireless devices 205-c, the wireless device 205-a may transmit the signal 215-a in accordance with a second or third harmonic window suppression scheme, as described further with reference to FIGS. 4B and 4C, respectively. In such examples, the second or third harmonic suppression scheme may enable the wireless device 205-a to allocate one or more REs in the signal 215-a to the one or more UEs or the one or more wireless devices 205-c using the same OFDM symbols. That is, the second or third harmonic suppression schemes may support more data transmission to the one or more UEs using the allocated one or more REs by including fewer harmonic suppression windows in the signal 215-a relative to the first harmonic suppression window scheme.

In some cases, the wireless device 205-a may transmit a first indication 225 of the resource allocation to the wireless device 205-b via the communication link 210-c. For example, the first indication 225 may indicate a harmonic suppression window scheme or a quantity of the one or more harmonic suppression windows. Additionally, or alternatively, the first indication 225 may request a success quality for detection at the wireless device 205-b. The wireless device 205-b may transmit a second indication 230 to the wireless device 205-a via the communication link 210-d. The second indication 230 may indicate the success quality for detection (e.g., in response to the first indication 225). In some examples, the wireless device 205-a may transmit a signal 215-b based on the second indication 230. For example, the wireless device 205-a may adjust (e.g., reduce or increase) a quantity of harmonic suppression windows or a quantity of suppressed higher-order harmonic frequencies in the signal 215-b based on the second indication 230. In some cases, the wireless device 205-a may decrease the quantity of harmonic suppression windows in the signal 215-b based on the wireless device 205-b indicating a detection success quality that satisfies a threshold (e.g., a signal-to-interference plus noise ratio (SINR) of the signal 220-a, a received signal strength indicator (RSSI) of the signal 220-a, or another metric of detection success quality, may satisfy the threshold). The wireless device 205-b may receive a signal 220-b based on the signal 215-b (e.g., the wireless device 205-c may reflect the signal 215-b and the signal 220-b may be the reflected signal).

Additionally, or alternatively, the wireless device 205-a may transmit a third indication 235 of a chip rate for use by the wireless device 205-c. For example, the wireless device 205-a may indicate the wireless device 205-c to use a lower chip rate (e.g., a lower M value) to decrease a width of the one or more harmonic suppression windows (e.g., to enable the wireless device 205-a to allocate more REs in the signal 215-a for the one or more UEs 115).

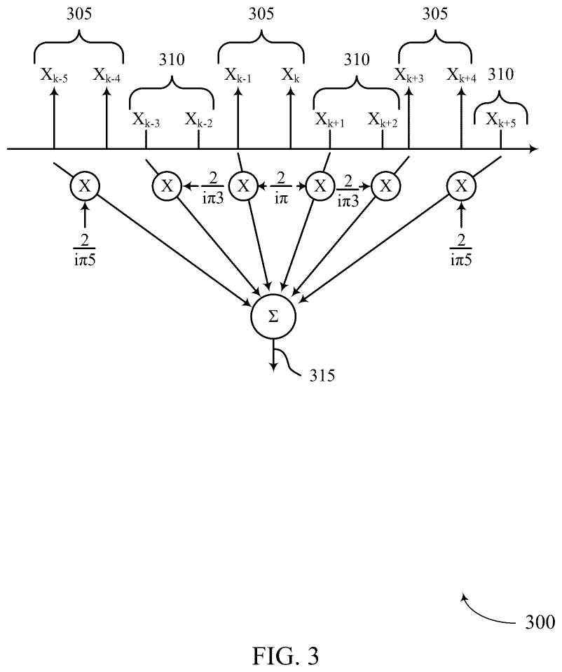

FIG. 3 shows an example of a resource allocation scheme 300 that supports transmitter-assisted harmonic avoidance at wireless nodes in accordance with one or more aspects of the present disclosure. The resource allocation scheme 300 may implement or be implemented by aspects of any of the wireless communications systems described with reference to FIGS. 1 and 2. For example, the resource allocation scheme 300 may illustrate a subcarrier resource allocation by a first wireless device, which may be an example of a UE 115, a network entity 105, or a wireless device 205 as described with reference to FIGS. 1 and 2. The first wireless device may allocate resources of a first signal in a frequency domain, X, across multiple subcarrier indices centered around a subcarrier, k. The subcarrier resource allocation may include one or more occupied REs 305 (e.g., subcarriers with non-zero energy) and one or more unoccupied REs 310 (e.g., subcarriers with zero energy).

The resource allocation scheme 300 illustrates resource allocations up to a fifth-order harmonic frequency (e.g., Xₖ₋₅ and its image tone Xₖ₊₅), but it is to be understood that the techniques described herein may apply to any order of harmonic frequency. The wireless device may transmit the first signal in a time domain (e.g., x(t)) based on performing an inverse Fourier transform operation on the one or more occupied REs 305 and the one or more unoccupied REs 310. A second wireless device may receive a second signal 315 that is a modulated version of the first signal (e.g., the second signal 315 may be the reflected first signal with a quantity of frequency shift for each RE).

The first wireless device may suppress higher-order harmonics based on mapping the one or more unoccupied REs 310 in the first signal. For example, if the first wireless device allocated energy to each of the REs in the first signal (e.g., did not map null symbols to one or more REs), the second wireless device may receive the second signal 315, Yₖ, in accordance with equation 1 (up to the fifth harmonic and where M=2):

$${Y}_{k} \approx \frac{2}{i π 5} {X}_{k - 5} + \frac{2}{i π 3} {X}_{k - 3} + \frac{2}{i π} {X}_{k - 1} + \frac{2}{i π} {X}_{k + 1} + \frac{2}{i π 3} {X}_{k + 3} + \frac{2}{i π 5} {X}_{k + 5} \qquad ( 2 )$$

However, based on mapping the null symbols to the one or more unoccupied REs 310, the higher order harmonics in equation 2 may be suppressed. For example, mapping null symbols to the one or more unoccupied REs 310 may cause the second signal 315 to be:

$${Y}_{k} \approx \frac{2}{i π 5} {X}_{k - 5} + \frac{2}{i π} {X}_{k - 1} + \frac{2}{i π 3} {X}_{k + 3} \qquad ( 3 )$$

The higher order harmonics in the second signal 315 may not be produced based on mapping the null symbols to one or more subcarriers of the first signal (e.g., to the one or more unoccupied REs 310). For example, three harmonic frequencies may contribute to the second signal 315 rather than six. The second wireless device may more accurately detect the first-order harmonic frequency (e.g., and thereby more accurately detect information associated with the first-order harmonic frequency) based on suppressing the higher-order harmonic frequencies.

FIGS. 4A through 4C show examples of harmonic suppression window schemes 400 that support transmitter-assisted harmonic avoidance at wireless nodes in accordance with one or more aspects of the present disclosure. The harmonic suppression window schemes 400 may implement or be implemented by aspects of any of the wireless communications systems described with reference to FIGS. 1 and 2. For example, a first wireless device, which may be an example of a wireless device 205 (e.g., a UE 115 or a network entity 105) may transmit one or more signals to a second wireless device in accordance with one or more of the harmonic suppression window schemes 400. The second wireless device may obtain information from one or more reflected signals based on detecting a frequency shift (e.g., relative to the one or more signals) of a first-order harmonic frequency in each of the one or more reflected signals. As described herein, the first wireless device may suppress interference from higher-order harmonic frequencies (e.g., harmonic frequencies above the first-order harmonic frequency) based on mapping null symbols to REs in the first signal (e.g., based on allocating zero energy to subcarriers that would be reflected by the higher-order harmonic frequencies in the reflected signal to the first-order harmonic frequency).

The first wireless device may allocate resources in one or more harmonic suppression windows 410 to suppress the higher-order harmonic frequencies. For example, the first wireless device may map one or more symbols 405 (e.g., occupied REs) and one or more null symbols 415 (e.g., unoccupied REs) to one or more REs within a respective harmonic suppression window 410. In some examples, a width 430 of a respective harmonic suppression window 410 may be based on a quantity of suppressed higher-order harmonic frequencies. The first wireless device may determine the width 430 based on suppressing up to an l-th harmonic frequency. For example, the width 430 of a harmonic suppression window 410 may be lM and may be centered around a subcarrier index k (e.g., the subcarrier index of the resource that may be detected in the first-order harmonic frequency of the one or more reflected signals). In some cases, the width 430 may ensure that, up to the l-th harmonic frequency, the first-order harmonic frequency is the strongest harmonic frequency in the one or more reflected signals to support the second wireless device in detecting the first-order harmonic frequency shift. For example, an edge 420 of a respective harmonic suppression window 410 may extend up to a subcarrier index

$$k + \frac{lM}{2} .$$

In some examples, the first wireless device may select a harmonic suppression window scheme 400 based on one or more parameters (e.g., based on a quantity of UEs 115 or other wireless devices in communication with the first wireless device).

FIG. 4A shows an example of a harmonic suppression window scheme 400-a. The harmonic suppression window scheme 400-a may include one or more harmonic suppression windows 410 and multiple symbols 405. A quantity of harmonic suppression windows 410, N_{W}, may be based on equation 4:

$${N}_{W} = \frac{\frac{B W}{Δ f}}{lM + 1} \qquad ( 4 )$$

where BW is the bandwidth of the carrier and Δf is the subcarrier spacing (e.g.,

$$\frac{BW}{Δ f}$$

may be the quantity of subcarriers). In some examples, multiple harmonic suppression windows 410 may support increased detection accuracy at the second wireless device. For example, if the second wireless device detects that three harmonic suppression windows 410 in the one or more reflected signals indicate a first value and that one harmonic suppression window 410 indicates a second value, the second wireless device may determine that the second value was erroneous (e.g., caused by interference).

The harmonic suppression window 410 may include one symbol 405-b mapped to a subcarrier index k that may be the index of the resource to be detected as the first-order harmonic frequency in the one or more reflected signals, while other subcarriers in the harmonic suppression window 410 may be mapped to null symbols (e.g., may be unoccupied REs). A next symbol 405 in the harmonic suppression window 410 may occur a delta quantity, Δ, of subcarriers from the subcarrier index k. For example, the symbol 405-a may occur at k−Δ and the symbol 405-c may occur at k+Δ, where Δ=lM+1. In some examples, the delta quantity may represent the period of occupied REs in the harmonic suppression window scheme 400-a (e.g., within the carrier, the first wireless device may allocate energy at REs in accordance with the period).

In some examples, the harmonic suppression window scheme 400-a may reduce a quantity of occupied REs (e.g., a quantity of data symbols) in the one or more signals (e.g., which may not be an issue from the second wireless device perspective if it may not be interested in detecting data in occupied REs). Additionally, or alternatively, the harmonic suppression window scheme 400-a may enable higher transmission power per occupied RE, which may improve detection performance (e.g., of data from a wireless node reflecting the one or more signals, data from the first wireless device, or both). For example, as the quantity of occupied REs is reduced, the first wireless device may allocate more energy in each remaining occupied RE while maintaining a total energy of the OFDM symbol. In some cases, the reduced quantity of occupied REs may be undesirable if the first wireless device is serving one or more other wireless devices (e.g., other UEs 115). In such cases, the first wireless device may transmit the one or more signals in accordance with a harmonic suppression window scheme 400-b or a harmonic suppression window scheme 400-c.

FIG. 4B shows an example of the harmonic suppression window scheme 400-b. The harmonic suppression window scheme 400-b may include a portion 435 of occupied and unoccupied REs (e.g., which may resist smaller-order harmonics) or a portion 440 of occupied REs (e.g., that include data). In some examples, the harmonic suppression window scheme 400-b may include the portion 435 of occupied and unoccupied REs on both sides of the harmonic suppression window 410 (e.g., between respective harmonic suppression windows 410). In some other examples, the harmonic suppression window scheme 400-b may include the portion 440 on both sides of the harmonic suppression window 410 (e.g., between respective harmonic suppression windows 410). In some cases, the harmonic suppression window scheme 400-b may include fewer harmonic suppression windows 410 relative to the harmonic suppression window scheme 400-a.

In some examples, the harmonic suppression window scheme 400-b may include guard bands 445 on either side of a respective harmonic suppression window 410. For example, a guard band 445-a may be between the portion 435 and an edge of the harmonic suppression window 410 and a guard band 445-b may be between the harmonic suppression window 410 and the portion 440. A width of the guard band 445 may be equal to

$$\frac{lM}{2} .$$

In some examples, the guard band may reduce, or prevent, interference with the first order harmonic (e.g., the symbol 405-b) caused by harmonic frequencies from the occupied REs in the portion 435 or the portion 440.

The first wireless device may use the occupied REs in the portion 435 or the portion 440 to communicate data with one or more UEs in communication with the first wireless device (e.g., fewer harmonic suppression windows 410 may enable more symbols to be mapped to more REs). In some examples, in the portion 435, the first wireless device may map one or more symbols to a first set of subcarriers and one or more null symbols to a second set of subcarriers based on higher-order harmonics of the one or more reflected signals (e.g., the first wireless device may map information to symbols that may not reflect in some higher-order harmonic frequencies to subcarriers of interest such as the first-order harmonic frequency). In some other examples, in the portion 440, the first wireless device may map symbols to all subcarriers outside of the harmonic suppression window 410 and guard bands 445. The first wireless device may select which subcarriers to map symbols to based on the harmonic suppression window 410 (e.g., for a relatively smaller harmonic suppression window 410, the first wireless device may use the portion 435, for relatively larger harmonic suppression window 410, the first wireless device may use the portion 440).

In some examples, the harmonic suppression window scheme 400-b may support activity detection of reflecting wireless nodes (e.g., nodes that reflect the one or more signals to the second wireless device) with a relatively small impact on ongoing UE communication. For example, the first wireless device or the second wireless device may not actively communicate with the reflecting wireless nodes (e.g., a wireless node may transmit a small amount information relatively infrequently). In such cases, the first wireless device may insert one harmonic suppression window 410 in the one or more signals to catch if any wireless node (e.g., any A-IoT device) begins transmitting (e.g., for device-originated traffic types). For example, a wireless node may modulate (e.g., in accordance with a reflection coefficient) one or more resources in the signals transmitted by the first wireless device that may be detectable by the second wireless device based on insertion of the harmonic suppression window 410 (e.g., without the harmonic suppression window 410, the second wireless device may not detect the quantity of frequency shift from the wireless node).

FIG. 4C shows an example of the harmonic suppression window scheme 400-c. The harmonic suppression window scheme 400-c may include the portion 435 of occupied and unoccupied REs or the portion 440 of occupied REs on either side of a harmonic suppression window 410. The harmonic suppression window scheme 400-c may include one or more occupied REs in the harmonic suppression window 410. Based on equation 1, the one or more reflected signals may include odd-order harmonic frequencies, but not even-order harmonic frequencies (e.g., there may not be any contributions from Xₖ₋₂, Xₖ₊₂, Xₖ₊₄). Accordingly, the first wireless device may allocate occupied REs within the harmonic suppression window 410 at subcarriers to be reflected to even-order harmonic frequencies in the one or more reflected signals without introducing interference at odd-order harmonic frequencies in the one or more reflected signals. For example, the first wireless device may allocate REs at subcarriers k+2n (e.g., for n=0, 1, 2, and so on) and k−1 (e.g., for the symbol 405-b) and may have unoccupied REs 415-a at k−(2n+1), except for k−1, and unoccupied REs 415-b at k+(2n+1) in the harmonic suppression window 410 (e.g., the first wireless device may map null symbols at subcarriers k−(2n+1), except for k−1, and at k+(2n+1)).

In some examples, the first wireless device may communicate information with one or more UEs via the occupied REs at the even-order harmonic frequencies. For example, the first wireless device may indicate that a portion of REs within a resource allocation are occupied with symbol information for the one or more UEs. Additionally, or alternatively, the first wireless device may modulate the one or more signals (e.g., an incident OFDM symbol) via periodic antenna load switching to transmit information (e.g., one or more bits). In some examples, the first wireless device may modulate the one or more signals based on including the harmonic suppression window 410 with a length lM+1 subcarriers with 2l+1 subcarriers being unoccupied. In some cases, the first wireless device may select the harmonic suppression window scheme 400-c based on configuring a wireless node (e.g., a reflecting node that reflects the one or more signals) to transmit a relatively low quantity of bits (e.g., 1 bit).

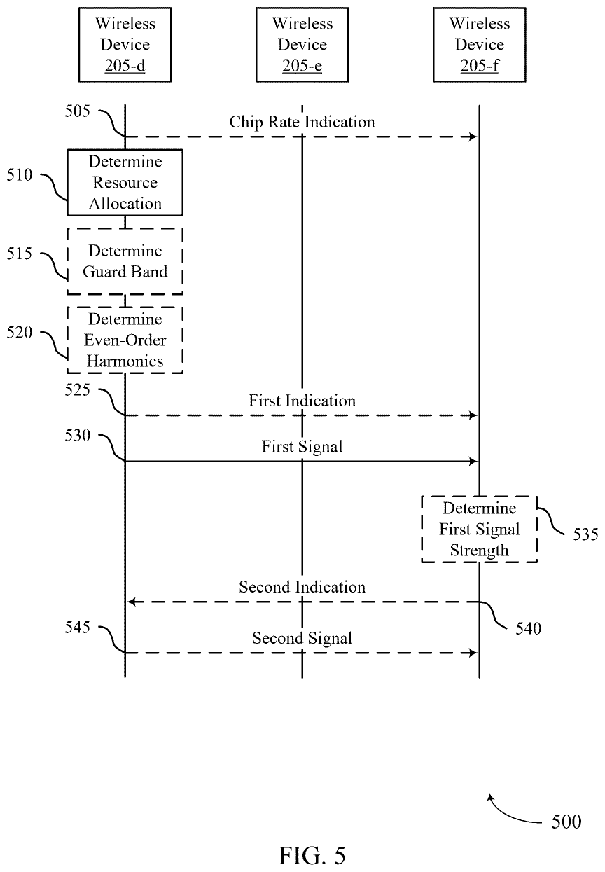

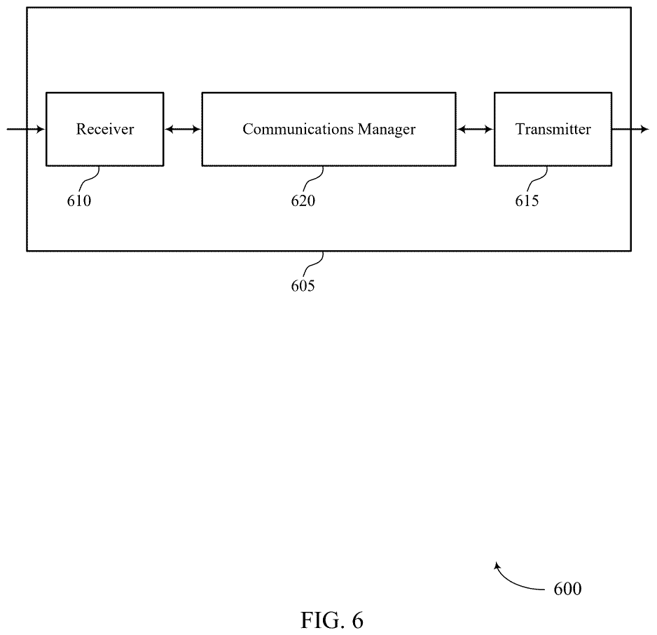

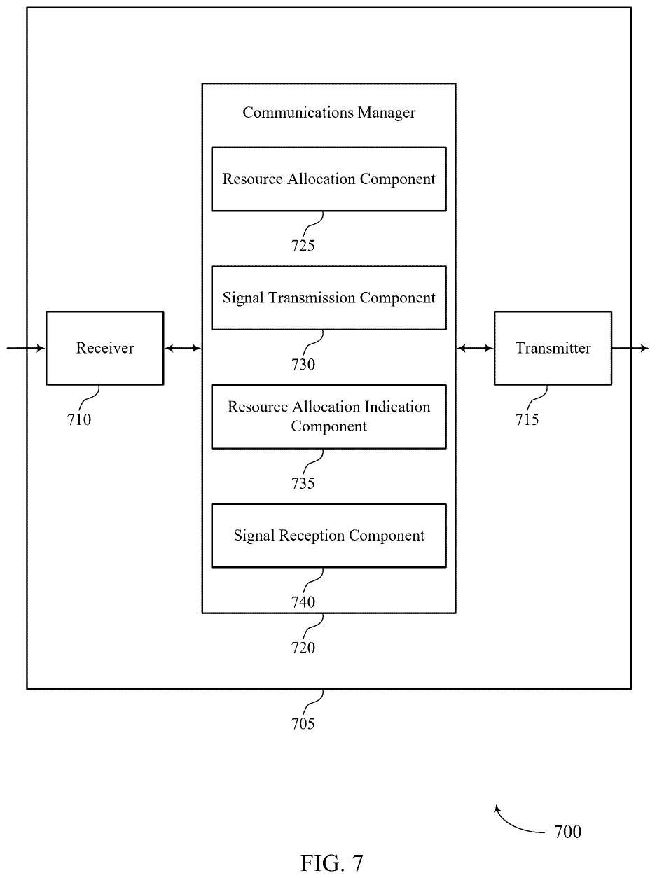

FIG. 5 shows an example of a process flow 500 that supports transmitter-assisted harmonic avoidance at wireless nodes in accordance with one or more aspects of the present disclosure. The process flow 500 may implement or be implemented by aspects of any of the wireless communications systems, resource allocation scheme, or harmonic suppression window schemes described with reference to FIGS. 1 through 4. For example, the process flow 500 includes a wireless device 205-d, a wireless device 205-e, and a wireless device 205-f, which may be examples of corresponding devices described herein, including with reference to FIGS. 1 and 2. For example, the wireless device 205-d may be a transmitting or emitting device (e.g., a UE 115 or a network entity 105), the wireless device 205-e may be a wireless node (e.g., an A-IoT device or a device that includes one or more RISs), and the wireless device 205-f may be a reader device (e.g., a second UE or a second network entity 105). The wireless device 205-e may receive one or more signals from the wireless device 205-d and reflect the one or more signals (e.g., with one or more frequency or phase shift modulations). In the following description of the process flow 500, operations between the wireless devices 205 may be added, omitted, or performed in a different order (with respect to the exemplary order shown).

At 505, the wireless device 205-d may transmit a chip rate indication of a chip rate for use by the wireless device 205-e. In some examples, the chip rate may refer to a rate at which chips (e.g., bits of a spreading code) are transmitted by the wireless device 205-e in a reflected signal.

At 510, the wireless device 205-d may determine a resource allocation across multiple REs. The resource allocation may include a first symbol mapped to a first RE (e.g., at a subcarrier index k) and one or more harmonic suppression windows. In some examples, the first RE may be associated with an incident signal to the wireless device 205-e, and each of the one or more harmonic suppression windows may include multiple null symbols mapped to REs corresponding to harmonics of the incident signal within a harmonic order of the first RE (e.g., higher-order harmonic frequencies). In such examples, the incident signal refers to a signal transmitted for the purpose of backscattering (e.g., reflection modulation), and thus may refer to a signal waveform prior to reflection at the wireless device 205-e (e.g., the incident signal may become the reflected signal after reflection modulation at the wireless device 205-e). In some examples, the multiple null symbols in the one or more harmonic suppression windows may be based on the chip rate.

In some examples, the resource allocation may further include a set of multiple second symbols, where each symbol of the set of multiple second symbols may be mapped to a respective RE outside of the one or more harmonic suppression windows. In some cases, the set of multiple second symbols may be mapped across all REs of the multiple REs outside of the one or more harmonic suppression windows. Additionally, or alternatively, the resource allocation may further include a second set of multiple null symbols. One or more null symbols of the second set of null symbols may be between one or more symbols of the set of multiple second symbols, and placement of the one or more null symbols may be associated with the harmonic order of the first RE (e.g., to resist or mitigate higher-order harmonic frequencies than the first-order harmonic frequency).

At 515, the wireless device 205-d may determine a guard band between a respective harmonic suppression window of the one or more harmonic suppression windows and a next symbol mapped to a next RE outside of the respective harmonic suppression window. In some examples, the guard band may include a second multiple of null symbols (e.g., to mitigate interference from the next symbol). A width of the guard band may be based on the harmonics of the incident signal and the chip rate of the wireless device 205-e.

At 520, the wireless device 205-d may determine one or more even-order harmonics of the harmonics of the incident signal. In some examples, the resource allocation may further include one or more second symbols mapped to one or more second REs within the one or more harmonic suppression windows that correspond to the one or more even-order harmonics.

At 525, the wireless device 205-d may transmit a first indication of the allocation to the wireless device 205-f. For example, the first indication may indicate that the resource allocation includes the first symbol and the one or more harmonic suppression windows.

At 530, the wireless device 205-d may transmit a first signal based on performing an inverse Fourier transform operation on the multiple resource elements. For example, the wireless device 205-d may transform the multiple resource elements from the frequency domain to the time domain using the inverse Fourier transform operation.

At 535, the wireless device 205-f may determine an SINR of the first signal, an RSSI of the first signal, or any combination thereof, based on receipt of the first signal. In examples, the wireless device 205-f may determine the SINR or the RSSI based on receiving a request from the wireless device 205-d (e.g., the wireless device 205-d may request a success quality for detection of the first signal at the wireless device 205-f).

At 540, the wireless device 205-f may transmit a second indication of the SINR, the RSSI, or any combination thereof. In some examples, the wireless device 205-f may transmit the second indication based on determining the SINR, the RSSI, or both. The wireless device 205-d may receive the second indication based on the first indication (e.g., based on indicating the resource allocation). Additionally, or alternatively, the wireless device 205-d may receive the second indication based on requesting the indication.

At 545, the wireless device 205-d may transmit a second signal associated with one or more second harmonic suppression windows. In some examples, a quantity of the one or more second harmonic suppression windows may be different from a quantity of the one or more harmonic suppression windows based on the second indication. Additionally, or alternatively, the wireless device 205-d may transmit the second signal associated with the one or more second harmonic suppression windows, where a second set of multiple null symbols in the one or more second harmonic suppression windows is different from a quantity of the multiple null symbols in the one or more harmonic suppression windows based on the second indication. The wireless device 205-d may increase or decrease the quantity of harmonic suppression windows or null symbols in the second signal based on the second indication indicating a detection quality that fails or satisfies a detection quality threshold, respectively.

FIG. 6 shows a block diagram 600 of a device 605 that supports transmitter-assisted harmonic avoidance at wireless nodes in accordance with one or more aspects of the present disclosure. The device 605 may be an example of aspects of a UE 115 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to transmitter-assisted harmonic avoidance at wireless nodes). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to transmitter-assisted harmonic avoidance at wireless nodes). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of transmitter-assisted harmonic avoidance at wireless nodes as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for determining a resource allocation across a set of multiple resource elements, where the resource allocation includes a first symbol mapped to a first resource element and one or more harmonic suppression windows, where the first resource element is associated with an incident signal to a second wireless device and each of the one or more harmonic suppression windows include a set of multiple null symbols mapped to resource elements corresponding to harmonics of the incident signal within a harmonic order of the first resource element. The communications manager 620 is capable of, configured to, or operable to support a means for transmitting a first signal based on performing an inverse Fourier transform operation on the set of multiple resource elements.

Additionally, or alternatively, the communications manager 620 may support wireless communications in accordance with examples as disclosed herein. For example, the communications manager 620 is capable of, configured to, or operable to support a means for receiving an indication of a resource allocation across a set of multiple resource elements, where the resource allocation includes a first symbol mapped to a first resource element and one or more harmonic suppression windows, where the first resource element is associated with an incident signal to a first wireless device and the one or more harmonic suppression windows include a set of multiple null symbols mapped to resource elements corresponding to harmonics of the incident signal within a harmonic order of the first resource element. The communications manager 620 is capable of, configured to, or operable to support a means for receiving, based on the indication, a first signal associated with the incident signal.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing and more efficient utilization of communication resources, among other examples.

FIG. 7 shows a block diagram 700 of a device 705 that supports transmitter-assisted harmonic avoidance at wireless nodes in accordance with one or more aspects of the present disclosure. The device 705 may be an example of aspects of a device 605, a UE 115, or a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to transmitter-assisted harmonic avoidance at wireless nodes). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to transmitter-assisted harmonic avoidance at wireless nodes). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of transmitter-assisted harmonic avoidance at wireless nodes as described herein. For example, the communications manager 720 may include a resource allocation component 725, a signal transmission component 730, a resource allocation indication component 735, a signal reception component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The resource allocation component 725 is capable of, configured to, or operable to support a means for determining a resource allocation across a set of multiple resource elements, where the resource allocation includes a first symbol mapped to a first resource element and one or more harmonic suppression windows, where the first resource element is associated with an incident signal to a second wireless device and each of the one or more harmonic suppression windows include a set of multiple null symbols mapped to resource elements corresponding to harmonics of the incident signal within a harmonic order of the first resource element. The signal transmission component 730 is capable of, configured to, or operable to support a means for transmitting a first signal based on performing an inverse Fourier transform operation on the set of multiple resource elements.

Additionally, or alternatively, the communications manager 720 may support wireless communications in accordance with examples as disclosed herein. The resource allocation indication component 735 is capable of, configured to, or operable to support a means for receiving an indication of a resource allocation across a set of multiple resource elements, where the resource allocation includes a first symbol mapped to a first resource element and one or more harmonic suppression windows, where the first resource element is associated with an incident signal to a first wireless device and the one or more harmonic suppression windows include a set of multiple null symbols mapped to resource elements corresponding to harmonics of the incident signal within a harmonic order of the first resource element. The signal reception component 740 is capable of, configured to, or operable to support a means for receiving, based on the indication, a first signal associated with the incident signal.

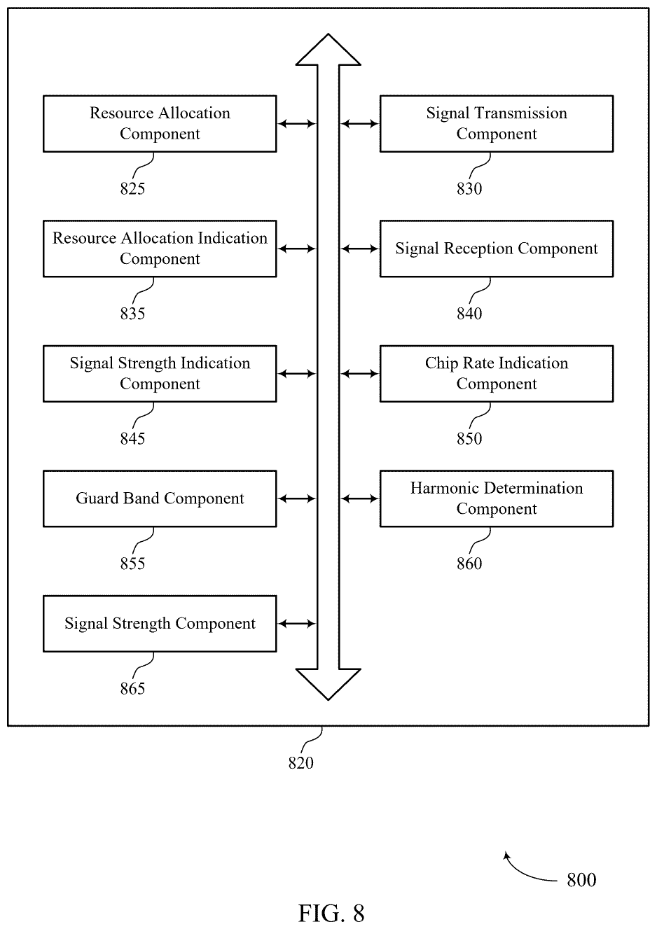

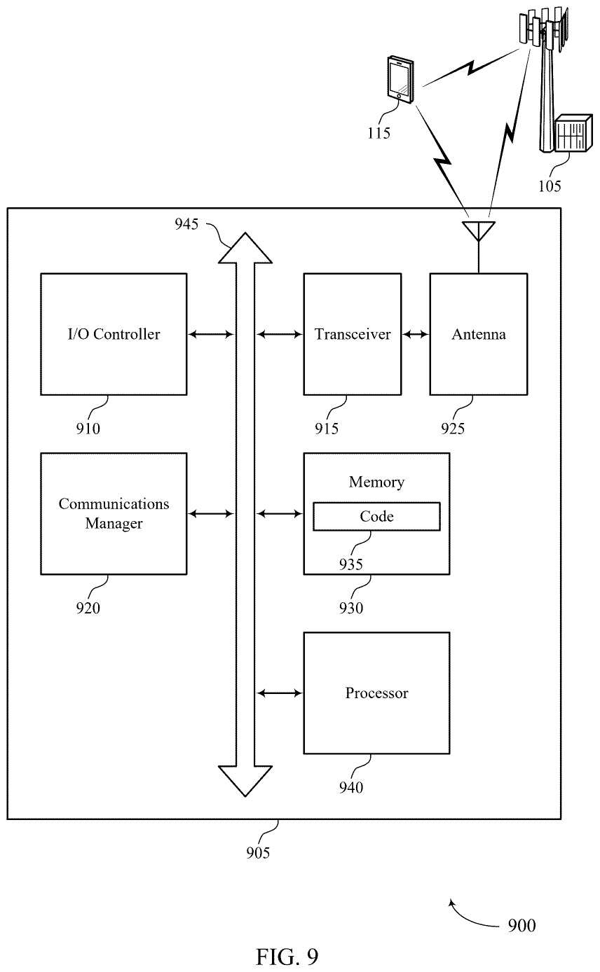

FIG. 8 shows a block diagram 800 of a communications manager 820 that supports transmitter-assisted harmonic avoidance at wireless nodes in accordance with one or more aspects of the present disclosure. The communications manager 820 may be an example of aspects of a communications manager 620, a communications manager 720, or both, as described herein. The communications manager 820, or various components thereof, may be an example of means for performing various aspects of transmitter-assisted harmonic avoidance at wireless nodes as described herein. For example, the communications manager 820 may include a resource allocation component 825, a signal transmission component 830, a resource allocation indication component 835, a signal reception component 840, a signal strength indication component 845, a chip rate indication component 850, a guard band component 855, a harmonic determination component 860, a signal strength component 865, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The resource allocation component 825 is capable of, configured to, or operable to support a means for determining a resource allocation across a set of multiple resource elements, where the resource allocation includes a first symbol mapped to a first resource element and one or more harmonic suppression windows, where the first resource element is associated with an incident signal to a second wireless device and each of the one or more harmonic suppression windows include a set of multiple null symbols mapped to resource elements corresponding to harmonics of the incident signal within a harmonic order of the first resource element. The signal transmission component 830 is capable of, configured to, or operable to support a means for transmitting a first signal based on performing an inverse Fourier transform operation on the set of multiple resource elements.

In some examples, the resource allocation indication component 835 is capable of, configured to, or operable to support a means for transmitting a first indication of the resource allocation. In some examples, the signal strength indication component 845 is capable of, configured to, or operable to support a means for receiving a second indication of a signal-to-interference plus noise ratio of the first signal, a received signal strength indicator of the first signal, or any combination thereof, based on the first indication.

In some examples, the signal transmission component 830 is capable of, configured to, or operable to support a means for transmitting a second signal associated with one or more second harmonic suppression windows, where a quantity of the one or more second harmonic suppression windows is different from a quantity of the one or more harmonic suppression windows based on the second indication. In some examples, the signal transmission component 830 is capable of, configured to, or operable to support a means for transmitting a second signal associated with one or more second harmonic suppression windows, where a second set of multiple null symbols in the one or more second harmonic suppression windows is different from a quantity of the set of multiple null symbols in the one or more harmonic suppression windows based on the second indication.

In some examples, the chip rate indication component 850 is capable of, configured to, or operable to support a means for transmitting a first indication of a chip rate for use by the second wireless device, where the set of multiple null symbols in the one or more harmonic suppression windows is based on the chip rate.

In some examples, the resource allocation further includes a set of multiple second symbols. In some examples, each symbol of the set of multiple second symbols is mapped to a respective resource element outside of the one or more harmonic suppression windows. In some examples, the set of multiple second symbols are mapped across all resource elements of the set of multiple resource elements outside of the one or more harmonic suppression windows. In some examples, the resource allocation further includes a second set of multiple null symbols. In some examples, one or more null symbols of the second set of multiple null symbols are between one or more symbols of the set of multiple second symbols. In some examples, placement of the one or more null symbols is associated with the harmonic order of the first resource element.

In some examples, the guard band component 855 is capable of, configured to, or operable to support a means for determining a guard band between a respective harmonic suppression window of the one or more harmonic suppression windows and a next symbol mapped to a next resource element outside of the respective harmonic suppression window, the guard band including a second set of multiple null symbols. In some examples, a width of the guard band is based on the harmonics of the incident signal and a chip rate of the second wireless device.

In some examples, the harmonic determination component 860 is capable of, configured to, or operable to support a means for determining one or more even-order harmonics of the harmonics of the incident signal, where the resource allocation further includes one or more second symbols mapped to one or more second resource elements within the one or more harmonic suppression windows that correspond to the one or more even-order harmonics.

Additionally, or alternatively, the communications manager 820 may support wireless communications in accordance with examples as disclosed herein. The resource allocation indication component 835 is capable of, configured to, or operable to support a means for receiving an indication of a resource allocation across a set of multiple resource elements, where the resource allocation includes a first symbol mapped to a first resource element and one or more harmonic suppression windows, where the first resource element is associated with an incident signal to a first wireless device and the one or more harmonic suppression windows include a set of multiple null symbols mapped to resource elements corresponding to harmonics of the incident signal within a harmonic order of the first resource element. The signal reception component 840 is capable of, configured to, or operable to support a means for receiving, based on the indication, a first signal associated with the incident signal.

In some examples, the signal strength component 865 is capable of, configured to, or operable to support a means for determining a signal-to-interference plus noise ratio of the first signal, a received signal strength indicator of the first signal, or any combination thereof based on receipt of the first signal. In some examples, the signal strength indication component 845 is capable of, configured to, or operable to support a means for transmitting a second indication of the signal-to-interference plus noise ratio, the received signal strength indicator, or any combination thereof.

In some examples, the signal reception component 840 is capable of, configured to, or operable to support a means for receiving a second signal associated with one or more second harmonic suppression windows, where a quantity of the one or more second harmonic suppression windows is different from a quantity of the one or more harmonic suppression windows based on the second indication.

In some examples, the signal reception component 840 is capable of, configured to, or operable to support a means for receiving a second signal associated with one or more second harmonic suppression windows, where a second set of multiple null symbols in the one or more second harmonic suppression windows is different from a quantity of the set of multiple null symbols in the one or more harmonic suppression windows based on the second indication.

FIG. 9 shows a diagram of a system 900 including a device 905 that supports transmitter-assisted harmonic avoidance at wireless nodes in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting transmitter-assisted harmonic avoidance at wireless nodes). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for determining a resource allocation across a set of multiple resource elements, where the resource allocation includes a first symbol mapped to a first resource element and one or more harmonic suppression windows, where the first resource element is associated with an incident signal to a second wireless device and each of the one or more harmonic suppression windows include a set of multiple null symbols mapped to resource elements corresponding to harmonics of the incident signal within a harmonic order of the first resource element. The communications manager 920 is capable of, configured to, or operable to support a means for transmitting a first signal based on performing an inverse Fourier transform operation on the set of multiple resource elements.

Additionally, or alternatively, the communications manager 920 may support wireless communications in accordance with examples as disclosed herein. For example, the communications manager 920 is capable of, configured to, or operable to support a means for receiving an indication of a resource allocation across a set of multiple resource elements, where the resource allocation includes a first symbol mapped to a first resource element and one or more harmonic suppression windows, where the first resource element is associated with an incident signal to a first wireless device and the one or more harmonic suppression windows include a set of multiple null symbols mapped to resource elements corresponding to harmonics of the incident signal within a harmonic order of the first resource element. The communications manager 920 is capable of, configured to, or operable to support a means for receiving, based on the indication, a first signal associated with the incident signal.

By including or configuring the communications manager 920 in accordance with examples as described herein, the device 905 may support techniques for improved communication reliability, improved user experience related to reduced processing, more efficient utilization of communication resources, and improved coordination between devices, among other examples.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of transmitter-assisted harmonic avoidance at wireless nodes as described herein, or the at least one processor 940 and the at least one memory 930 may be otherwise configured to, individually or collectively, perform or support such operations.

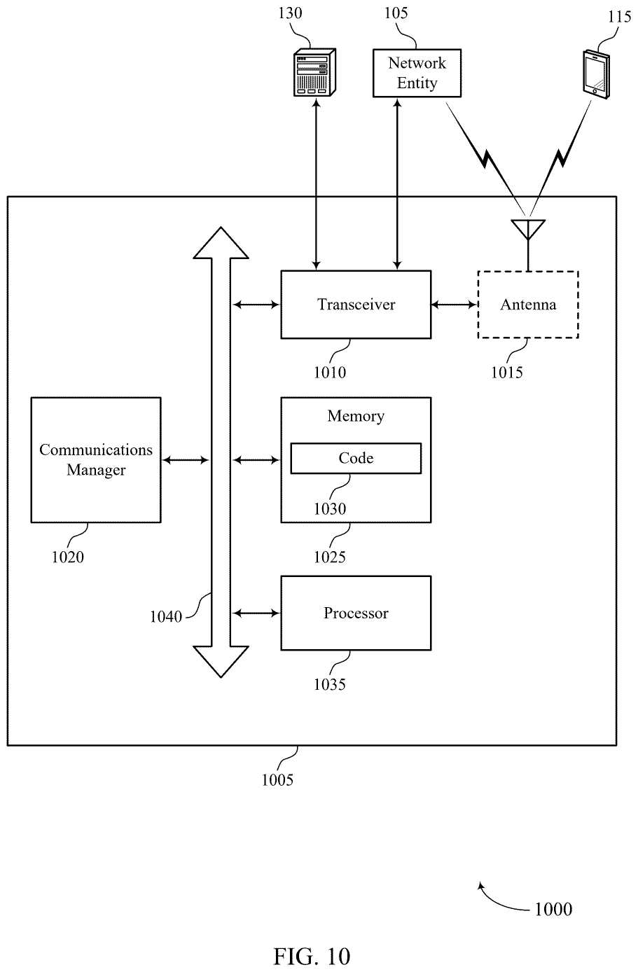

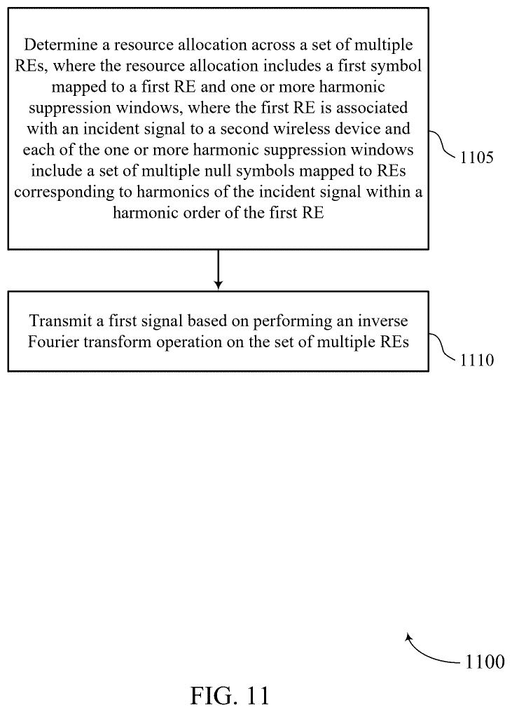

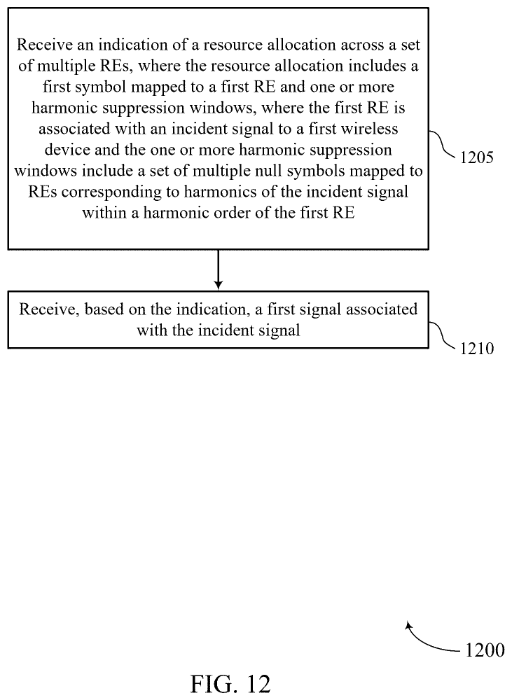

FIG. 10 shows a diagram of a system 1000 including a device 1005 that supports transmitter-assisted harmonic avoidance at wireless nodes in accordance with one or more aspects of the present disclosure. The device 1005 may be an example of or include components of a device 605, a device 705, or a network entity 105 as described herein. The device 1005 may communicate with other network devices or network equipment such as one or more of the network entities 105, UEs 115, or any combination thereof. The communications may include communications over one or more wired interfaces, over one or more wireless interfaces, or any combination thereof. The device 1005 may include components that support outputting and obtaining communications, such as a communications manager 1020, a transceiver 1010, one or more antennas 1015, at least one memory 1025, code 1030, and at least one processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (e.g., the at least one processor 1035, the at least one memory 1025, or both), may be included in a chip or chip assembly that is installed in the device 1005. In some examples, the transceiver 1010 may be operable to support communications via one or more communications links (e.g., communication link(s) 125, backhaul communication link(s) 120, a midhaul communication link 162, a fronthaul communication link 168).

The at least one memory 1025 may include RAM, ROM, or any combination thereof. The at least one memory 1025 may store computer-readable, computer-executable, or processor-executable code, such as the code 1030. The code 1030 may include instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (e.g., when compiled and executed) to perform functions described herein. In some cases, the at least one memory 1025 may include, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (e.g., one or more of the at least one memory 1025) to cause the device 1005 to perform various functions (e.g., functions or tasks supporting transmitter-assisted harmonic avoidance at wireless nodes). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (e.g., one or more physical nodes and supporting software such as operating systems, virtual machines, or container instances) that may host the functions (e.g., by executing code 1030) to perform the functions of the device 1005. The at least one processor 1035 may be any one or more suitable processors capable of executing scripts or instructions of one or more software programs stored in the device 1005 (such as within one or more of the at least one memory 1025).

In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. For example, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the at least one memory 1025, the code 1030, and the at least one processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with one or more other network entities 105, and may include a controller or scheduler for controlling communications with UEs 115 (e.g., in cooperation with the one or more other network devices). In some examples, the communications manager 1020 may support an X2 interface within an LTE/LTE-A wireless communications network technology to provide communication between network entities 105.

The communications manager 1020 may support wireless communications in accordance with examples as disclosed herein. For example, the communications manager 1020 is capable of, configured to, or operable to support a means for determining a resource allocation across a set of multiple resource elements, where the resource allocation includes a first symbol mapped to a first resource element and one or more harmonic suppression windows, where the first resource element is associated with an incident signal to a second wireless device and each of the one or more harmonic suppression windows include a set of multiple null symbols mapped to resource elements corresponding to harmonics of the incident signal within a harmonic order of the first resource element. The communications manager 1020 is capable of, configured to, or operable to support a means for transmitting a first signal based on performing an inverse Fourier transform operation on the set of multiple resource elements.

Additionally, or alternatively, the communications manager 1020 may support wireless communications in accordance with examples as disclosed herein. For example, the communications manager 1020 is capable of, configured to, or operable to support a means for receiving an indication of a resource allocation across a set of multiple resource elements, where the resource allocation includes a first symbol mapped to a first resource element and one or more harmonic suppression windows, where the first resource element is associated with an incident signal to a first wireless device and the one or more harmonic suppression windows include a set of multiple null symbols mapped to resource elements corresponding to harmonics of the incident signal within a harmonic order of the first resource element. The communications manager 1020 is capable of, configured to, or operable to support a means for receiving, based on the indication, a first signal associated with the incident signal.

By including or configuring the communications manager 1020 in accordance with examples as described herein, the device 1005 may support techniques for improved communication reliability, more efficient utilization of communication resources, improved coordination between devices, and improved utilization of processing capability, among other examples.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of transmitter-assisted harmonic avoidance at wireless nodes as described herein, or the at least one processor 1035 and the at least one memory 1025 may be otherwise configured to, individually or collectively, perform or support such operations.

FIG. 11 shows a flowchart illustrating a method 1100 that supports transmitter-assisted harmonic avoidance at wireless nodes in accordance with one or more aspects of the present disclosure. The operations of the method 1100 may be implemented by a UE or a network entity or its components as described herein. For example, the operations of the method 1100 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1105, the method may include determining a resource allocation across a set of multiple REs, where the resource allocation includes a first symbol mapped to a first RE and one or more harmonic suppression windows, where the first RE is associated with an incident signal to a second wireless device and each of the one or more harmonic suppression windows include a set of multiple null symbols mapped to REs corresponding to harmonics of the incident signal within a harmonic order of the first RE. The operations of 1105 may be performed in accordance with examples as disclosed herein. In some examples, aspects of the operations of 1105 may be performed by a resource allocation component 825 as described with reference to FIG. 8.

At 1110, the method may include transmitting a first signal based on performing an inverse Fourier transform operation on the set of multiple REs. The operations of 1110 may be performed in accordance with examples as disclosed herein. In some examples, aspects of the operations of 1110 may be performed by a signal transmission component 830 as described with reference to FIG. 8.

FIG. 12 shows a flowchart illustrating a method 1200 that supports transmitter-assisted harmonic avoidance at wireless nodes in accordance with one or more aspects of the present disclosure. The operations of the method 1200 may be implemented by a UE or a network entity or its components as described herein. For example, the operations of the method 1200 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include receiving an indication of a resource allocation across a set of multiple REs, where the resource allocation includes a first symbol mapped to a first RE and one or more harmonic suppression windows, where the first RE is associated with an incident signal to a first wireless device and the one or more harmonic suppression windows include a set of multiple null symbols mapped to REs corresponding to harmonics of the incident signal within a harmonic order of the first RE. The operations of 1205 may be performed in accordance with examples as disclosed herein. In some examples, aspects of the operations of 1205 may be performed by a resource allocation indication component 835 as described with reference to FIG. 8.

At 1210, the method may include receiving, based on the indication, a first signal associated with the incident signal. The operations of 1210 may be performed in accordance with examples as disclosed herein. In some examples, aspects of the operations of 1210 may be performed by a signal reception component 840 as described with reference to FIG. 8.

The following provides an overview of aspects of the present disclosure:

Aspect 1: A method for wireless communications at a first wireless device, comprising: determining a resource allocation across a plurality of REs, wherein the resource allocation comprises a first symbol mapped to a first RE and one or more harmonic suppression windows, wherein the first RE is associated with an incident signal to a second wireless device and each of the one or more harmonic suppression windows comprise a plurality of null symbols mapped to REs corresponding to harmonics of the incident signal within a harmonic order of the first RE; and transmitting a first signal based at least in part on performing an inverse Fourier transform operation on the plurality of REs.

Aspect 2: The method of aspect 1, further comprising: transmitting a first indication of the resource allocation; and receiving a second indication of a SINR of the first signal, a RSSI of the first signal, or any combination thereof, based at least in part on the first indication.

Aspect 3: The method of aspect 2, further comprising: transmitting a second signal associated with one or more second harmonic suppression windows, wherein a quantity of the one or more second harmonic suppression windows is different from a quantity of the one or more harmonic suppression windows based at least in part on the second indication.

Aspect 4: The method of any of aspects 2 through 3, further comprising: transmitting a second signal associated with one or more second harmonic suppression windows, wherein a second plurality of null symbols in the one or more second harmonic suppression windows is different from a quantity of the plurality of null symbols in the one or more harmonic suppression windows based at least in part on the second indication.

Aspect 5: The method of any of aspects 1 through 4, further comprising: transmitting a first indication of a chip rate for use by the second wireless device, wherein the plurality of null symbols in the one or more harmonic suppression windows is based at least in part on the chip rate.

Aspect 6: The method of any of aspects 1 through 5, wherein the resource allocation further comprises a plurality of second symbols, each symbol of the plurality of second symbols is mapped to a respective RE outside of the one or more harmonic suppression windows.

Aspect 7: The method of aspect 6, wherein the plurality of second symbols are mapped across all REs of the plurality of REs outside of the one or more harmonic suppression windows.

Aspect 8: The method of aspect 6, wherein the resource allocation further comprises a second plurality of null symbols, one or more null symbols of the second plurality of null symbols are between one or more symbols of the plurality of second symbols, and placement of the one or more null symbols is associated with the harmonic order of the first RE.

Aspect 9: The method of any of aspects 1 through 8, further comprising: determining a guard band between a respective harmonic suppression window of the one or more harmonic suppression windows and a next symbol mapped to a next RE outside of the respective harmonic suppression window, the guard band comprising a second plurality of null symbols.

Aspect 10: The method of aspect 9, wherein a width of the guard band is based at least in part on the harmonics of the incident signal and a chip rate of the second wireless device.

Aspect 11: The method of any of aspects 1 through 8, further comprising: determining one or more even-order harmonics of the harmonics of the incident signal, wherein the resource allocation further comprises one or more second symbols mapped to one or more second REs within the one or more harmonic suppression windows that correspond to the one or more even-order harmonics.

Aspect 12: A method for wireless communications at a second wireless device, comprising: receiving an indication of a resource allocation across a plurality of REs, wherein the resource allocation comprises a first symbol mapped to a first RE and one or more harmonic suppression windows, wherein the first RE is associated with an incident signal to a first wireless device and the one or more harmonic suppression windows comprise a plurality of null symbols mapped to REs corresponding to harmonics of the incident signal within a harmonic order of the first RE; and receiving, based at least in part on the indication, a first signal associated with the incident signal.

Aspect 13: The method of aspect 12, further comprising: determining a SINR of the first signal, a RSSI of the first signal, or any combination thereof based at least in part on receipt of the first signal; and transmitting a second indication of the SINR, the RSSI, or any combination thereof.

Aspect 14: The method of aspect 13, further comprising: receiving a second signal associated with one or more second harmonic suppression windows, wherein a quantity of the one or more second harmonic suppression windows is different from a quantity of the one or more harmonic suppression windows based at least in part on the second indication.

Aspect 15: The method of any of aspects 13 through 14, further comprising: receiving a second signal associated with one or more second harmonic suppression windows, wherein a second plurality of null symbols in the one or more second harmonic suppression windows is different from a quantity of the plurality of null symbols in the one or more harmonic suppression windows based at least in part on the second indication.

Aspect 16: A first wireless device for wireless communications, comprising one or more memories storing processor-executable code, and one or more processors coupled with the one or more memories and individually or collectively operable to execute the code to cause the first wireless device to perform a method of any of aspects 1 through 11.

Aspect 17: A first wireless device for wireless communications, comprising at least one means for performing a method of any of aspects 1 through 11.

Aspect 18: A non-transitory computer-readable medium storing code for wireless communications, the code comprising instructions executable by one or more processors to perform a method of any of aspects 1 through 11.

Aspect 19: A second wireless device for wireless communications, comprising one or more memories storing processor-executable code, and one or more processors coupled with the one or more memories and individually or collectively operable to execute the code to cause the second wireless device to perform a method of any of aspects 12 through 15.

Aspect 20: A second wireless device for wireless communications, comprising at least one means for performing a method of any of aspects 12 through 15.

Aspect 21: A non-transitory computer-readable medium storing code for wireless communications, the code comprising instructions executable by one or more processors to perform a method of any of aspects 12 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
determine a resource allocation across a plurality of resource elements, wherein the resource allocation comprises a first symbol mapped to a first resource element and one or more harmonic suppression windows, wherein the first resource element is associated with an incident signal to a second wireless device and each of the one or more harmonic suppression windows comprise a plurality of null symbols mapped to resource elements corresponding to harmonics of the incident signal within a harmonic order of the first resource element; and
transmit a first signal based at least in part on performing an inverse Fourier transform operation on the plurality of resource elements.

2. The first wireless device of claim 1, wherein the one or more processors are individually or collectively further operable to execute the code to cause the first wireless device to:
transmit a first indication of the resource allocation; and
receive a second indication of a signal-to-interference plus noise ratio of the first signal, a received signal strength indicator of the first signal, or any combination thereof, based at least in part on the first indication.

3. The first wireless device of claim 2, wherein the one or more processors are individually or collectively further operable to execute the code to cause the first wireless device to:
transmit a second signal associated with one or more second harmonic suppression windows, wherein a quantity of the one or more second harmonic suppression windows is different from a quantity of the one or more harmonic suppression windows based at least in part on the second indication.

4. The first wireless device of claim 2, wherein the one or more processors are individually or collectively further operable to execute the code to cause the first wireless device to:
transmit a second signal associated with one or more second harmonic suppression windows, wherein a second plurality of null symbols in the one or more second harmonic suppression windows is different from a quantity of the plurality of null symbols in the one or more harmonic suppression windows based at least in part on the second indication.

5. The first wireless device of claim 1, wherein the one or more processors are individually or collectively further operable to execute the code to cause the first wireless device to:
transmit a first indication of a chip rate for use by the second wireless device, wherein the plurality of null symbols in the one or more harmonic suppression windows is based at least in part on the chip rate.

6. The first wireless device of claim 1, wherein:
the resource allocation further comprises a plurality of second symbols; and
each symbol of the plurality of second symbols is mapped to a respective resource element outside of the one or more harmonic suppression windows.

7. The first wireless device of claim 6, wherein the plurality of second symbols are mapped across all resource elements of the plurality of resource elements outside of the one or more harmonic suppression windows.

8. The first wireless device of claim 6, wherein:
the resource allocation further comprises a second plurality of null symbols;
one or more null symbols of the second plurality of null symbols are between one or more symbols of the plurality of second symbols; and
placement of the one or more null symbols is associated with the harmonic order of the first resource element.

9. The first wireless device of claim 1, wherein the one or more processors are individually or collectively further operable to execute the code to cause the first wireless device to:
determine a guard band between a respective harmonic suppression window of the one or more harmonic suppression windows and a next symbol mapped to a next resource element outside of the respective harmonic suppression window, the guard band comprising a second plurality of null symbols.

10. The first wireless device of claim 9, wherein a width of the guard band is based at least in part on the harmonics of the incident signal and a chip rate of the second wireless device.

11. The first wireless device of claim 1, wherein the one or more processors are individually or collectively further operable to execute the code to cause the first wireless device to:
determine one or more even-order harmonics of the harmonics of the incident signal, wherein the resource allocation further comprises one or more second symbols mapped to one or more second resource elements within the one or more harmonic suppression windows that correspond to the one or more even-order harmonics.

12. A second wireless device, comprising:
one or more memories storing processor-executable code; and
one or more processors coupled with the one or more memories and individually or collectively operable to execute the code to cause the second wireless device to:
receive an indication of a resource allocation across a plurality of resource elements, wherein the resource allocation comprises a first symbol mapped to a first resource element and one or more harmonic suppression windows, wherein the first resource element is associated with an incident signal to a first wireless device and the one or more harmonic suppression windows comprise a plurality of null symbols mapped to resource elements corresponding to harmonics of the incident signal within a harmonic order of the first resource element; and
receive, based at least in part on the indication, a first signal associated with the incident signal.

13. The second wireless device of claim 12, wherein the one or more processors are individually or collectively further operable to execute the code to cause the second wireless device to:
determine a signal-to-interference plus noise ratio of the first signal, a received signal strength indicator of the first signal, or any combination thereof based at least in part on receipt of the first signal; and
transmit a second indication of the signal-to-interference plus noise ratio, the received signal strength indicator, or any combination thereof.

14. The second wireless device of claim 13, wherein the one or more processors are individually or collectively further operable to execute the code to cause the second wireless device to:
receive a second signal associated with one or more second harmonic suppression windows, wherein a quantity of the one or more second harmonic suppression windows is different from a quantity of the one or more harmonic suppression windows based at least in part on the second indication.

15. The second wireless device of claim 13, wherein the one or more processors are individually or collectively further operable to execute the code to cause the second wireless device to:
receive a second signal associated with one or more second harmonic suppression windows, wherein a second plurality of null symbols in the one or more second harmonic suppression windows is different from a quantity of the plurality of null symbols in the one or more harmonic suppression windows based at least in part on the second indication.

16. A method for wireless communications at a first wireless device, comprising:
determining a resource allocation across a plurality of resource elements, wherein the resource allocation comprises a first symbol mapped to a first resource element and one or more harmonic suppression windows, wherein the first resource element is associated with an incident signal to a second wireless device and each of the one or more harmonic suppression windows comprise a plurality of null symbols mapped to resource elements corresponding to harmonics of the incident signal within a harmonic order of the first resource element; and
transmitting a first signal based at least in part on performing an inverse Fourier transform operation on the plurality of resource elements.

17. The method of claim 16, further comprising:
transmitting a first indication of the resource allocation; and
receiving a second indication of a signal-to-interference plus noise ratio of the first signal, a received signal strength indicator of the first signal, or any combination thereof, based at least in part on the first indication.

18. The method of claim 17, further comprising:
transmitting a second signal associated with one or more second harmonic suppression windows, wherein a quantity of the one or more second harmonic suppression windows is different from a quantity of the one or more harmonic suppression windows based at least in part on the second indication.

19. The method of claim 17, further comprising:
transmitting a second signal associated with one or more second harmonic suppression windows, wherein a second plurality of null symbols in the one or more second harmonic suppression windows is different from a quantity of the plurality of null symbols in the one or more harmonic suppression windows based at least in part on the second indication.

20. The method of claim 16, further comprising:
transmitting a first indication of a chip rate for use by the second wireless device, wherein the plurality of null symbols in the one or more harmonic suppression windows is based at least in part on the chip rate.

21. The method of claim 16, wherein:
the resource allocation further comprises a plurality of second symbols; and
each symbol of the plurality of second symbols is mapped to a respective resource element outside of the one or more harmonic suppression windows.

22. The method of claim 21, wherein the plurality of second symbols are mapped across all resource elements of the plurality of resource elements outside of the one or more harmonic suppression windows.

23. The method of claim 21, wherein:
the resource allocation further comprises a second plurality of null symbols;
one or more null symbols of the second plurality of null symbols are between one or more symbols of the plurality of second symbols; and
placement of the one or more null symbols is associated with the harmonic order of the first resource element.

24. The method of claim 16, further comprising:
determining a guard band between a respective harmonic suppression window of the one or more harmonic suppression windows and a next symbol mapped to a next resource element outside of the respective harmonic suppression window, the guard band comprising a second plurality of null symbols.

25. The method of claim 24, wherein a width of the guard band is based at least in part on the harmonics of the incident signal and a chip rate of the second wireless device.

26. The method of claim 16, further comprising:
determining one or more even-order harmonics of the harmonics of the incident signal, wherein the resource allocation further comprises one or more second symbols mapped to one or more second resource elements within the one or more harmonic suppression windows that correspond to the one or more even-order harmonics.

27. A method for wireless communications at a second wireless device, comprising:
receiving an indication of a resource allocation across a plurality of resource elements, wherein the resource allocation comprises a first symbol mapped to a first resource element and one or more harmonic suppression windows, wherein the first resource element is associated with an incident signal to a first wireless device and the one or more harmonic suppression windows comprise a plurality of null symbols mapped to resource elements corresponding to harmonics of the incident signal within a harmonic order of the first resource element; and
receiving, based at least in part on the indication, a first signal associated with the incident signal.

28. The method of claim 27, further comprising:
determining a signal-to-interference plus noise ratio of the first signal, a received signal strength indicator of the first signal, or any combination thereof based at least in part on receipt of the first signal; and
transmitting a second indication of the signal-to-interference plus noise ratio, the received signal strength indicator, or any combination thereof.

29. The method of claim 28, further comprising:
receiving a second signal associated with one or more second harmonic suppression windows, wherein a quantity of the one or more second harmonic suppression windows is different from a quantity of the one or more harmonic suppression windows based at least in part on the second indication.

30. The method of claim 28, further comprising:
receiving a second signal associated with one or more second harmonic suppression windows, wherein a second plurality of null symbols in the one or more second harmonic suppression windows is different from a quantity of the plurality of null symbols in the one or more harmonic suppression windows based at least in part on the second indication.
